(19) United States
(12) Patent Application Publication
(10) Pub. No.: US 2021/0295284 A1
(43) Pub. Date: Sep. 23, 2021

(54) SYSTEMS FOR AUTOMATIC CALCULATION OF MANUAL AND TAG TOLL PAYMENT

(71) Applicant: TOYOTA MOTOR NORTH AMERICA, INC., Plano, TX (US)

(72) Inventor: Sriranjan Tadimari, Plano, TX (US)

(73) Assignee: TOYOTA MOTOR NORTH AMERICA, INC., Plano, TX (US)

(21) Appl. No.: 16/821,238

(22) Filed: Mar. 17, 2020

(51) Int. Cl. G06Q 20/08; G07B 15/06; G01C 21/34

(52) U.S. Cl. CPC G06Q 20/085; G06Q 2240/00; G01C 21/3407; G07B 15/06

(57) ABSTRACT

A system of calculation of manual and tag tolls in a vehicle includes a computing device having a processor and a non-transitory computer-readable memory, an input device and an output device communicatively coupled to the computing device, and a machine-readable instruction set stored in the non-transitory computer-readable memory that causes the system to perform a number of steps. The steps include determining, through the input device, a vehicle parameter and whether cash or an automatic payment method will be used for paying tolls on a trip between an origin and a destination within a mapped area, calculating, using the computing device, a first cost of tolls for the trip using cash and a second cost of tolls for the trip using the automatic payment method, and providing a feedback, through the output device, to a user comparing the first cost of tolls and the second cost of tolls.

### TECHNICAL FIELD

The present specification generally relates to provisioning of information and notification about toll payments in a vehicle during a trip and, more specifically, to systems capable of calculating manual and tag tolls for a trip and providing feedback to a user or driver of a vehicle.

### BACKGROUND

Current systems for calculating tolls, like TollGuru® Calculator, allow a user to only select one of two options: whether toll roads should be included or excluded in a route. Moreover, the current systems are not integrated with relevant information for a vehicle trip and does not differentiate how much a toll road costs with an automatic payment method (e.g. a tag toll pass) as opposed to paying for the toll with cash, especially because the amount of toll paid using cash and the automatic payment method could be very different for different kinds of vehicle.

### SUMMARY

The present specification relates to systems capable of calculating manual and tag tolls for a trip and providing feedback to a user or driver of a vehicle. The system includes a computing device having a processor and a non-transitory computer-readable memory, an input device communicatively coupled to the computing device, an output device communicatively coupled to the computing device, and a machine-readable instruction set stored in the non-transitory computer-readable memory that causes the system to perform a number of steps. The steps include determining, through the input device, a vehicle parameter and whether cash or an automatic payment method will be used for paying tolls on a trip between an origin and a destination within a mapped area and then calculating, using the computing device, a first cost of tolls for the trip using cash and a second cost of tolls for the trip using the automatic payment method. The steps further include providing a feedback, through the output device, to a user comparing the first cost of tolls and the second cost of tolls.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a system of calculation of manual and tag tolls in a vehicle, according to one or more embodiments shown and described herein;

FIG. 2 depicts a sample schedule of toll charges at a toll plaza stored in a database of toll plazas connected to the system of FIG. 1, according to one or more embodiments shown and described herein; and

FIG. 3 depicts a block diagram of a method performed by the system of FIG. 1, according to one or more embodiments shown and described herein.

### DETAILED DESCRIPTION

Embodiments described herein relate to a system capable of calculating manual and tag tolls for a trip and providing feedback to a user or driver of a vehicle. The system obtains an input, either automatically or through a user, about a vehicle parameter and whether cash or an automatic payment method (e.g. a tag toll pass such as E-Z Pass®) is available for paying tolls during the trip. The system then consults one or more databases having map information and toll cost information of toll plazas along a route taken during the trip. The system calculates a cost of tolls for the trip using cash as well as a cost of tolls for the trip using the automatic payment method to provide a feedback to the user or driver of the vehicle comparing the costs. Various other aspects of the disclosure and variations thereof are illustrated or implied through the descriptions of the embodiments below.

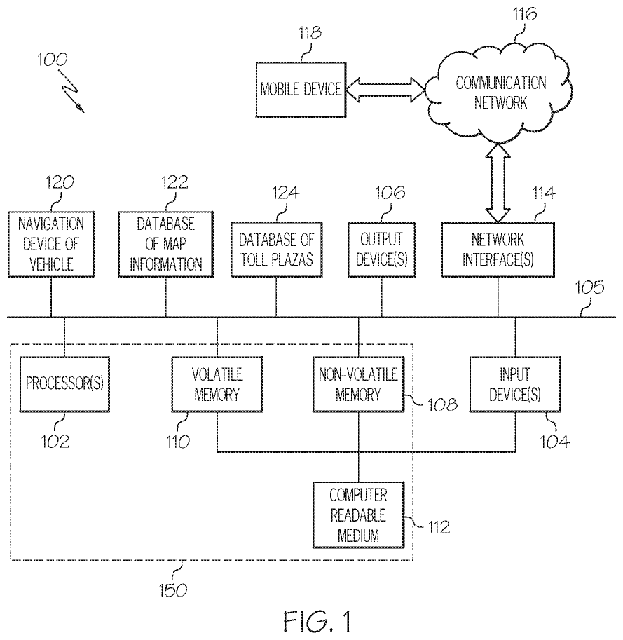

Referring to the figures, FIG. 1 depicts the system 100 of calculation of manual and tag tolls in a vehicle. The system 100 includes one or more processors 102, one or more input devices 104, one or more output devices 106, and a communication path 105. The system 100 further includes a non-volatile memory 108 and/or a volatile memory 110 connected to a computer-readable medium 112, and a network interface 114. The one or more processors 102, the non-volatile memory 108 and/or the volatile memory 110, and the computer-readable medium 112 form a computing device 150 in the system 100. As depicted in FIG. 1, the system 100 is also connected, along the communication path 105, to a navigation device 120, a database of map information 122, and a database of toll plazas 124.

The processor(s) 102 may be any device capable of executing a machine-readable instruction set stored in a computer-readable memory such as the non-volatile memory 108 and/or the volatile memory 110. Accordingly, the processor(s) 102 may be an electronic controller, an integrated circuit, a microchip, a computer, or any other computing device. The processor(s) 102 is communicatively coupled to the other components of the system 100 by the communication path 105, which communicatively couples any number of the processor(s) 102 with one another, and allows the other components to operate in a distributed computing environment. Specifically, each of the components may operate as a node that may send and/or receive data.

The input device(s) 104 may include, by way of example, any type of microphone, mouse, keyboard, disk/media drive, memory stick/thumb-drive, memory card, pen, touch-input device, biometric scanner, voice/auditory input device, motion-detector, camera, scale, etc. In some embodiments, the input device(s) 104 are configured to receive commands and/or inputs (for example, via a user interface) from a user within the vehicle having the system 100 or respond to prompts generated by the output device(s) 104, as described above. In some embodiments, the commands or responses may be auditory signals received by a microphone, which are subsequently processed by the processor(s) 102 using a known or yet-to-be-developed speech recognition algorithm(s) stored in the non-volatile memory 108 and/or the volatile memory 110. The inputted information may include a vehicle parameter and whether cash or an automatic payment method (e.g. a tag toll pass such as E-Z Pass) will be used for paying tolls during the trip. The vehicle parameter may be a number of users in the vehicle, a number of axles in the vehicle, a number of rear wheels in the vehicle, energy efficiency of the vehicle, and time of commencement of the trip, among others. In other embodiments, the input device(s) 104 are configured to receive inputs automatically from a different vehicle system.

The output device(s) 106 may include a video display as well as speakers, headphones, projectors, wearable-displays, holographic displays, a heads-up display (HUD), and/or printers, for example. The output device(s) 106 are configured to output information to a user or driver of the vehicle having the system 100. The information outputted may include a feedback comparing costs of tolls, an indication whether the automatic payment method or the cash should be used, and/or a prompt to recharge the automatic payment method. In some embodiments, the output device(s) 106 may be communicatively coupled to and/or integrated with the navigation device 120 and provide feedback and/or prompts therethrough.

The communication path 105 is formed from any medium that is capable of transmitting a signal such as, for example, conductive wires, conductive traces, optical waveguides, or the like. The communication path 105 may also refer to the expanse in which electromagnetic radiation and their corresponding electromagnetic waves traverses. Moreover, the communication path 105 may be formed from a combination of mediums capable of transmitting signals. In one embodiment, the communication path 105 comprises a combination of conductive traces, conductive wires, connectors, and buses that cooperate to permit the transmission of electrical data signals to and from the various components of the system 100. Accordingly, the communication path 105 may comprise a bus, such as for example a LIN bus, a CAN bus, a VAN bus, and the like. Additionally, it is noted that the term “signal” means a waveform (e.g., electrical, optical, magnetic, mechanical or electromagnetic) capable of traveling through a medium such as DC, AC, sinusoidal-wave, triangular-wave, square-wave, vibration, and the like, capable of traveling through a medium. As used herein, the term “communicatively coupled” means that coupled components are capable of exchanging data signals with one another such as, for example, electrical signals via conductive medium, electromagnetic signals via air, optical signals via optical waveguides, and the like.

In some embodiments, the processor(s) 102 is communicatively coupled to the non-volatile memory 108 and/or the volatile memory 110. The non-volatile memory 108 may comprise read-only memory (ROM), flash memories, hard drives, while the volatile memory 110 may comprise random access memory (RAM). The non-volatile memory 108 is configured to store information inputted, automatically or through user input, through the input device(s) 104.

The non-volatile memory 108 and/or volatile memory 110 are configured to store a machine-readable instruction set that can be accessed and executed by the processor(s) 102. The machine-readable instruction set may comprise logic or algorithm(s) written in any programming language of any generation (e.g., 1GL, 2GL, 3GL, 4GL, or 5GL) such as, for example, machine language that may be directly executed by the processor(s) 102, or assembly language, object-oriented programming (OOP), scripting languages, microcode, etc., that may be compiled or assembled into machine readable instructions and stored in the non-volatile memory 108 and/or the volatile memory 110. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The computer-readable medium 112 may comprise a plurality of computer-readable mediums, each of which may be either a computer-readable storage medium or a computer-readable signal medium. The computer-readable medium 112 may reside, for example, within the input device(s) 104, the non-volatile memory 108, the volatile memory 110, or any combination thereof. The computer-readable medium 112 can include tangible media that is able to store the machine-readable instruction set associated with, or used by, the system 100. The computer-readable medium 112 includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. The computer-readable medium 112 may also include, for example, a system or device that is of a magnetic, optical, semiconductor, or electronic type. The computer-readable medium 112 is non-transitory, and excludes propagated signals and carrier waves.

The system 100 is communicatively coupled to a communication network 116 by way of the network interface 114. The components of the system 100 may be physically coupled or may be communicatively and operably coupled through the communication path 105 and/or the communication network 116. In different embodiments, the communication network 116 may be a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM. In some embodiments, the communication network 116 connects the system 100 with a mobile device 118 of a user such that the user can provide inputs to the system 100 or receive output from the system 100. In different embodiments, the mobile device 118 may be a mobile phone, a tablet, a portable computer, or a remote computing device.

The system 100 is communicatively connected to a database of map information 122 and a database of toll plazas 124. The database of map information 122 includes map and location information of different toll plazas located within a mapped area in which a vehicle having the system 100 may undertake a trip between an origin and a destination. The processor(s) 102 uses this information to determine one or more tolled route segments between the origin and the destination of the trip.

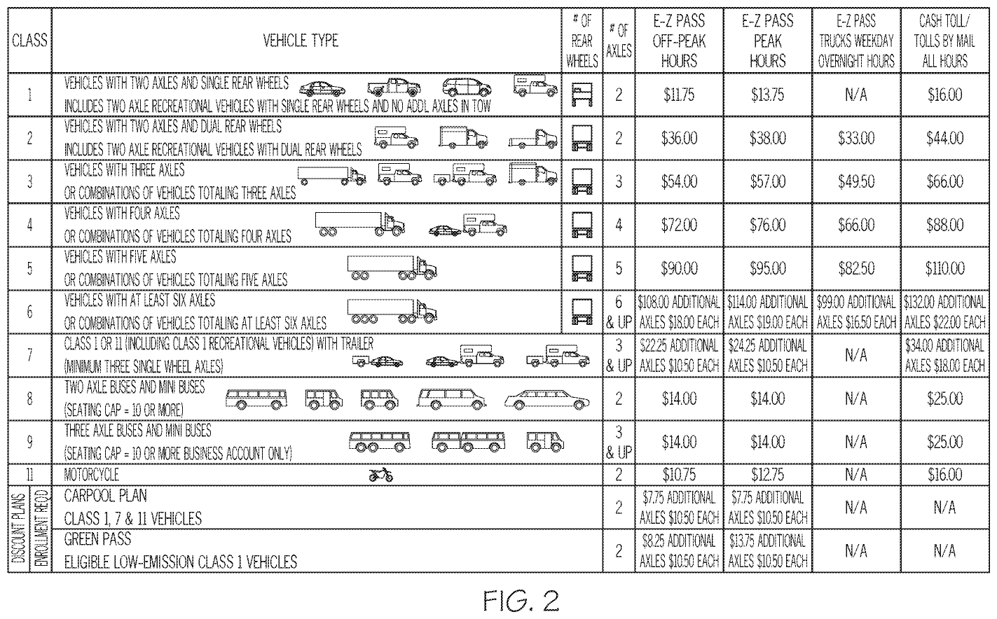

The database of toll plazas 124 stores toll information for different toll plazas located within the mapped area. The toll information for a particular toll plaza includes, among other information, a schedule of charges for vehicles crossing that particular toll plaza. FIG. 2 depicts a sample schedule of toll charges at a toll plaza stored in the database of toll plazas 124. As shown in FIG. 2, the sample schedule of toll charges may list the different toll costs for different vehicles, according to the vehicle parameter noted above. The toll costs may vary by the kind of vehicle, number of axles in the vehicle and the number of rear wheels in the vehicle. The toll costs also may vary depending on the use of the automatic payment method, i.e. E-Z Pass or cash and whether the vehicle is a low-emission vehicle such as but not limited to, electric vehicles, hybrid vehicles, and the like. Further, the toll costs may vary by the time of commencement of the trip. For example, tolls costs are different during peak traffic hours (for example between 7-9 am and 5-7 pm), off-peak hours, weekday overnight hours for trucks, etc.

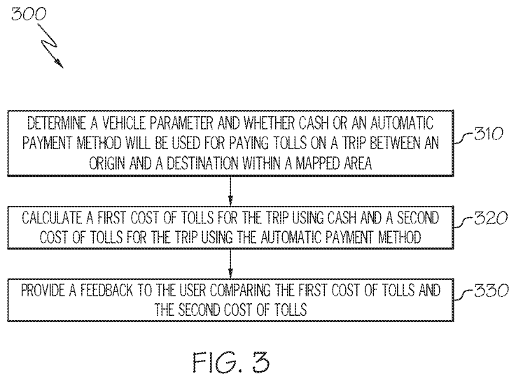

FIG. 3 depicts a block diagram of a method 300 performed by the system 100. During operation, in block 310, the system 100 determines a vehicle parameter and whether cash or an automatic payment method will be used for paying tolls on a trip between an origin and a destination within a mapped area. As mentioned above, the vehicle parameter may be a number of users in the vehicle, a number of axles in the vehicle, a number of rear wheels in the vehicle, energy efficiency of the vehicle, and time of commencement of the trip, among others. The information in block 310 may be inputted through the input device(s) 104 either via a user interface therein or automatically via another vehicle system.

In block 320, the system 100 calculates, using the computing device 150, a first cost of tolls for the trip using cash and a second cost of tolls for the trip using the automatic payment method. During this step, the system 100 determines tolled route segments between the origin and the destination of the trip based on information obtained from the database of map information 122 and the database of toll plazas 124. The system 100 then determines the first cost of tolls by adding cost of tolls using cash for individual tolled route segments and the second cost of tolls by adding cost of tolls using automatic payment method for individual tolled route segments.

In block 330, the system 100 provides a feedback to a user or a driver of the vehicle through the output device(s) 106 and/or the navigation device 120, if the output device(s) 106 is integrated with the navigation device 120. In some embodiments, the feedback may compare the first cost of tolls and the second cost of tolls. In other embodiments, the feedback may include an indication whether the automatic payment method or the cash should be preferably used. Such an indication may be based on whether the cost of tolls when paid by one form of payment would be less than when paid by other forms of payment. Accordingly, the system may prompt the user or the driver to accept the preferred mode of payment. In such a case, the user may accept to pay by the automatic payment method or by cash, if he or she is carrying sufficient cash; otherwise, the user or the driver may reject the preferred mode of payment, for example, if the preferred mode of payment is cash and he or she is not carrying sufficient cash.

In yet other embodiments, the feedback may incorporate a prompt to recharge the automatic payment method, if the balance on the automatic payment method is low or insufficient to cover the cost of the trip or an upcoming toll payment. In such embodiments, if the user responds positively to the prompt via the user interface, the system 100 executes a financial transaction to recharge the automatic payment method. Alternatively, the system 100 may automatically execute a financial transaction to recharge the automatic payment method, upon a determination that the balance is low or insufficient to cover the cost of the trip or the upcoming toll payment.

The systems described herein can be advantageously used to determine toll costs associated with using cash and an automatic payment method. This may help determine a preferred mode of toll payment for a trip based on a comparative cost-benefit analysis. In some cases, a user may accept the preferred mode of payment prompted by the system. In other cases, the user may also reject the preferred mode of payment, for example, if the system determines that the preferred mode of payment is cash and he or she is not carrying sufficient cash.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system of calculation of manual and tag tolls in a vehicle, the system comprising:
a computing device comprising a processor and a non-transitory computer readable memory;
an input device communicatively coupled to the computing device;
an output device communicatively coupled to the computing device; and
a machine-readable instruction set stored in the non-transitory computer-readable memory that causes the system to perform at least the following steps when executed by the processor:
determining, through the input device, a vehicle parameter and whether cash or an automatic payment method will be used for paying tolls on a trip between an origin and a destination within a mapped area;
calculating, using the computing device, a first cost of tolls for the trip using cash and a second cost of tolls for the trip using the automatic payment method; and
providing a feedback, through the output device, to a user comparing the first cost of tolls and the second cost of tolls.

2. The system of claim 1, wherein the step of calculating a first cost of tolls for the trip using cash and a second cost of tolls for the trip using the automatic payment method in the machine-readable instruction set further includes the step of:
determining tolled route segments between the origin and the destination;
determining the first cost by adding cost of tolls using cash for individual tolled route segments; and
determining the second cost by adding cost of tolls using automatic payment method for individual tolled route segments.

3. The system of claim 1, wherein the computing device is communicatively coupled to a database of toll information for individual toll plazas within the mapped area.

4. The system of claim 1, wherein the vehicle parameter is one or more of: a number of users in the vehicle, a number of axles in the vehicle, a number of rear wheels in the vehicle, energy efficiency of the vehicle, and time of commencement of the trip.

5. The system of claim 1, wherein the input device comprises a user interface configured to obtain input from the user on one or both of: the vehicle parameter and whether the vehicle is associated with an automatic payment method.

6. The system of claim 1, wherein the input device is communicatively coupled to at least one of: a navigation device, a mobile phone, a tablet and a portable computer.

7. The system of claim 1, wherein the feedback includes an indication to the user of whether the automatic payment method or the cash should be preferably used.

8. The system of claim 1, wherein the output device is communicatively coupled to a navigation device in the vehicle.

9. The system of claim 1, wherein the computing device is configured to execute a financial transaction to recharge the automatic payment method.

10. The system of claim 1, wherein the computing device is communicatively coupled to a database storing map and location information of individual toll plazas within the mapped area.
